(19) United States
(12) Patent Application Publication
(10) Pub. No.: US 2009/0289098 A1
(43) Pub. Date: Nov. 26, 2009

(54) Chip Mounting Apparatus and Chip Mounting Method

(76) Inventors: Katsumi Terada, Shiga (JP); Mikio Kawakami, Shiga (JP)

Correspondence Address: SMITH PATENT OFFICE, 1901 PENNSYLVANIA AVENUE N W, SUITE 901, WASHINGTON, DC, 20006, US

(21) Appl. No.: 12/085,964

(22) PCT Filed: Nov. 30, 2006
(86) PCT No.: PCT/JP2006/323888

§ 371 Date: Jun. 3, 2008

(30) Foreign Application Priority Data
Dec. 6, 2005 (JP) 2005-352270

(51) Int. Cl. B23K 20/02; B23Q 15/14

(52) U.S. Cl. 228/102; 228/12

(57) ABSTRACT

A chip mounting apparatus is provided with a drive control means. The drive control means is provided with a tool holder whereupon a tool for applying pressure to a chip is mounted, a holder supporting means for supporting the tool holder to be vertically moved, a drive means for vertically moving the holder supporting means, and a position detecting means for detecting a relative position of the tool holder to the holder supporting means. The drive control means controls the height and the pressurizing force of the tool, based on the position of the tool holder when the tool and the chip are one over another and brought into contact with a substrate. A chip mounting method is also provided. Short-circuit failures between adjacent solder bumps can be prevented and chips can be mounted with high yield and reliability.

### TECHNICAL FIELD OF THE INVENTION

The present invention relates to a chip mounting apparatus and a chip mounting method for mounting a chip such as an integrated circuit element to a substrate such as a printed board.

### BACKGROUND ART OF THE INVENTION

As a method for mounting a chip such as an integrated circuit element to a substrate such as a printed board, a method due to thermal press bonding is known. In this method, a chip is pressed to a substrate by a thermal-press bonding tool, the chip is heated to melt a solder bump of the chip, and the bump of the chip is bonded to an electrode of the substrate by soldering. In this thermal press bonding step of a conventional chip mounting method, when the solder bump is brought into contact with the electrode of the substrate, the solder bump is at a temperature lower than a melting point of the solder, and after a certain time passes from the contact of the solder bump, the solder bump melts. As to the timing of melting of the solder bump, when a load value detected by a load detecting means has decreased down to a predetermined value or lower, it is determined that the solder bump has been molten, and then, the thermal-press bonding tool is lifted up and maintained at a predetermined height and a heater is turned off, and the molten solder is cooled and solidified (for example, Patent document 1).

Further, in order to increase the bonding strength of a solder bump, a chip mounting method is known wherein a chip and a substrate are preheated at a temperature lower than a solder melting point, the chip and the substrate are brought into contact with each other and rubbed with each other, the chip and the substrate are then heated at a temperature of the solder melting point or higher at a state where the solder bump is maintained at the contact condition, the solder bump is pushed in by a predetermined amount, and a fine vibration is given in a direction perpendicular to the chip and substrate (for example, Patent document 2).

Patent document 1: JP-A-11-145197
Patent document 2: JP-A-2005-209833

### DISCLOSURE OF THE INVENTION

### Problems to be solved by the Invention

However, in the method as described in Patent document 1 wherein the timing of melting of the solder bump is determined by a change of the load value detected by the chip load detecting means, there are the following problems. First, when the press bonding tool is heated so as to heat the solder bump at a temperature of the melting point or higher, because the height of the lower end of the press bonding tool is maintained at a constant height, the press bonding tool elongates in the height direction by thermal expansion by the timing when the solder is molten. By this elongation of the press bonding tool, the weight of a lifting block including the press bonding tool is applied to the solder bump as a stress. Then, the solder is molten before the detected load value reaches a predetermined value, the elongation of the press bonding tool is also added, and there may be a case where the solder bump is broken by being pressed. The press broken solder bump may cause a short-circuit failure between adjacent solder bumps, and it may cause a problem of reducing the yield and reliability of a product. In particular, in a semiconductor package with solder bumps at a fine pitch (for example, a pitch of 30 μm), because the bump height is small, even in a case of an elongation of the press bonding tool due to a fine thermal expansion, the solder bump may be press broken, and there may occur a short-circuit failure between adjacent solder bumps. Further, it is very difficult to set a load value which does not cause the press breakage of the solder bump, and there is also a problem that it takes a long time to set such a load value.

Further, in the method as described in Patent document 2 wherein a fine vibration is given in a direction perpendicular to the chip and substrate when heated at a temperature of the solder melting point or higher, a bump crush in that the solder bump is crushed may happen depending upon the setting of the pressurizing force of a bonding head, and there is a problem that a stable chip bonding cannot be carried out.

Accordingly, in chip mounting for mounting a chip such as an integrated circuit element to a substrate such as a printed board, an object of the present invention is to provide chip mounting apparatus and chip mounting method high in yield and reliability, which can prevent occurrence of a short-circuit failure between adjacent solder bumps, and can achieve the gap between the chip and the substrate after bonding at a predetermined constant gap.

### Means for solving the Problems

To achieve the above objects, a chip mounting apparatus according to the present invention has a tool for applying a pressure to a chip, a tool holder mounted with the tool, a tool holder supporting means for supporting the tool holder to be vertically moved, a drive means for vertically moving the tool holder supporting means, and a tool holder position detecting means for detecting a relative position of the tool holder to the tool holder supporting means, and the apparatus comprises a drive control means for controlling a height and a pressurizing force of the tool, based on a position of the tool holder when the tool and the chip are one over another and brought into contact with a substrate.

In this chip mounting apparatus, since the tool holder position detecting means detects the position of the tool holder when the tool and the chip are one over another and brought into contact with the substrate and based on this detected position the height and the pressurizing force of the tool are controlled, the position of the tool can be detected at a high accuracy, a short-circuit failure between adjacent bumps does not occur, and a chip mounting apparatus with a high reliability can be provided. Further, because the height of the tool can be controlled at a high accuracy, the gap between the chip and the substrate can be controlled at a predetermined constant gap.

In the above-described chip mounting apparatus according to the present invention, it is preferred that the drive control means comprises means for calculating and controlling an amount to be lifted up of the tool holder from a parameter with respect to a gap between the chip and the substrate when the chip and the substrate are brought into contact with each other, a parameter with respect to a pushing-in amount when the chip is pushed in to the substrate, and a parameter with respect to the relative position of the tool holder detected by the tool holder position detecting means. By providing such a calculation means and calculating and controlling the lifting-up amount of the tool holder, the gap between the chip and the substrate may be automatically controlled by the respective parameters, and a stable bonding between the chip and the substrate may be carried out.

Further, the present invention provides a chip mounting method for press bonding a bump of a chip to an electrode provided on a substrate by moving down a tool holder, supported to be vertically moved by a tool holder supporting means, from an upper side of the substrate held by a substrate holding stage, and by applying a pressure to the chip via a tool mounted on the tool holder, the method comprising the steps of pressing the bump of the chip to the electrode of the substrate at a predetermined pressure by moving down the tool; detecting a relative position of the tool holder to the tool holder supporting means by a tool holder position detecting means; heating the bump of the chip, formed by a solder, at a temperature of a melting point of the solder or higher by supplying an electric power to a heater of the tool; determining that the bump of the chip has been molten when the relative position of the tool holder, detected by the tool holder position detecting means, has reached a predetermined position; and thereafter, lifting up the tool holder supporting means.

In this chip mounting method, after the tool is moved down and the bump of the chip is pressed to the substrate at a predetermined load, by determining that the bump is molten when the position of the tool holder reaches a predetermined position or a lower position after starting to heat the chip and by lifting up the tool, occurrence of a short-circuit failure between adjacent solder bumps can be surely prevented, and a desirable mounting can be carried out in a short period of time.

In the above-described chip mounting method according to the present invention, it is preferred that, after the bump of the chip has been molten, a relative friction is generated between the bump of the chip and the electrode of the substrate, and an oxide layer on a surface of the solder is broken and removed by the friction. In such a method, the oxide layer on the surface of the solder may be surely removed over a predetermined region, thereby improving the wettability greatly and providing an excellent chip mounting method employing melting of solder.

Further, it is preferred that the bump of the chip is bonded to the electrode provided on the substrate at a condition where a pressure of the chip when the bump of the chip is molten is set at a pressure lower than a pressure in a fluidized solder. By setting the pressure of the chip when the bump of the chip is molten at a pressure lower than a inside pressure (buoyancy) of the fluidized solder, the surface layer of the solder is not broken by the pressure of the chip and a bump crush does not occur, thereby greatly improving the property for preventing a short-circuit failure between solder bumps and providing a chip mounting method excellent in yield and reliability.

Further, a method may also be employed wherein, by the tool holder position detecting means, a first position of the tool holder when the bump of the chip and the electrode of the substrate come into contact with each other is detected, then a second position of the tool holder when the tool is pushed in to the side of the substrate is detected, and thereafter a third position of the tool holder when the tool is heated by supplying an electric power to the heater of the tool is detected, then it is determined that the bump of the chip has been molten when a position of the tool holder, detected by the tool holder position detecting means, has reached a fourth position, the tool holder supporting means is lifted up until the tool holder reaches the first position, and while a gap between the chip and the substrate is maintained at a constant gap, the solder is solidified. In this method, by the tool holder position detecting means, the first position of the tool holder when the bump of the chip and the electrode of the substrate come into contact with each other is detected. Next, the second position of the tool holder when the tool is pushed in to the side of the substrate is detected. Next, the third position of the tool holder when the tool is heated by supplying an electric power to the heater of the tool is detected. Next, it is determined that the bump of the chip has been molten when the position of the tool holder, detected by the tool holder position detecting means, has reached the fourth position. Next, the tool holder supporting means is lifted up until the tool holder reaches the first position. Next, while the gap between the chip and the substrate is maintained at a constant gap, the solder is solidified. Thus, because the a change in the height position of the tool due to the thermal expansion of the tool, when an electric power is supplied to the heater of the tool and the tool is heated, is detected and the bump of the chip and the electrode of the substrate are bonded, the third position of the tool holder when the solder bump is molten can be accurately detected by amending the change of the thermal expansion of the tool. Further, because the solder bump is solidified at a condition where the gap between the chip and the substrate is maintained constant, in charging of underfill into a portion between the chip and the substrate carried out after the mounting process, there occurs no irregularity in the charging of underfill. Therefore, in a semiconductor package requiring a high-speed signal processing, the properties in respective electrodes become uniform, and the reliability of the products can be improved.

Further, a method may also be employed wherein an amount of lifting up of the tool holder at the time of solidifying the solder is determined from a predetermined gap between the chip and the substrate when the bump of the chip has been solidified, a gap between the chip and the substrate when the bump of the chip and the electrode of the substrate come into contact with each other, a pushing-in amount when the tool is pushed in to the side of the substrate, the first position of the tool holder, the second position of the tool holder, the third second position of the tool holder, and the fourth position of the tool holder. In such a method, it becomes possible to measure the variations of the heights of the bump, the substrate and the electrode and the amount of the deformation of the bump for each mounting operation by the tool holder position detecting means in consideration of the thermal expansion of the heater, and it becomes possible to automatically control the gap between the chip and the substrate by the feedback of the position of the tool so that the gap becomes a preset desirable value. Therefore, the time for deciding the gap by a prior trial can be omitted, and in a short period of time, the chip mounting onto the substrate can be carried out at a reliable condition setting without operator's mistake.

Furthermore, a method may also be employed wherein a time from the timing of heating the tool by supplying an electric power to the heater of the tool to the timing when the bump of the chip is molten is measured beforehand, and in a case where a height of the tool does not reach a height at the time when the bump is molten within the time measured beforehand, a set temperature of an upper heater or a lower heater is raised so as to melt the solder. In such a method, by memorizing the measured melting time, it becomes possible to operate it as a melting monitor timer in the following respective chip mounting processes, and by providing such a melting monitor timer, even if there is a dispersion in melting of solder bump, the chip mounting onto the substrate can be carried out in a stable time.

### EFFECT ACCORDING TO THE INVENTION

Thus, in the chip mounting apparatus and the chip mounting method according to the present invention, in chip mounting for mounting a chip such as an integrated circuit element to a substrate such as a printed board, in particular, even in a semiconductor package requiring a high-speed signal processing, occurrence of a short-circuit failure between adjacent solder bumps can be surely prevented, and the gap between the chip and the substrate after bonding can be at a desirable predetermined constant gap surely and stably. As a result, a chip mounting high in yield and reliability can be realized.

### BRIEF EXPLANATION OF THE DRAWINGS

FIG. 1 is a schematic vertical sectional view of a chip mounting apparatus according to a first example of the present invention.

FIG. 2 is an enlarged partial vertical sectional view showing a state at the time of starting mounting in the apparatus depicted in FIG. 1.

FIG. 3 is an enlarged partial vertical sectional view showing a state where a bump is brought into contact with a substrate in the apparatus depicted in FIG. 1.

FIG. 4 is an enlarged partial vertical sectional view showing a state where a tool holder begins to leave from a tool holder supporting means in the apparatus depicted in FIG. 1.

FIG. 5 is an enlarged partial vertical sectional view showing a state where a Z-axis feeding is stopped in the apparatus depicted in FIG. 1.

FIG. 6 is an enlarged partial vertical sectional view showing a state where a position of a tool holder is changed by heating of a tool in the apparatus depicted in FIG. 1.

FIG. 7 is an enlarged partial vertical sectional view showing a state where a tool holder is moved down by melting of a bump in the apparatus depicted in FIG. 1.

FIG. 8 is an enlarged partial vertical sectional view showing a state where a tool holder supporting means is lifted up in the apparatus depicted in FIG. 1.

FIG. 9 is an enlarged partial vertical sectional view showing a state where a tool holder is lifted up in the apparatus depicted in FIG. 1.

FIG. 10 is a timing chart of the chip mounting method according to the first example.

FIG. 11 is an explanation diagram showing a positional relationship between a chip and a substrate in the chip mounting method according to the first example.

FIG. 12 is a schematic vertical sectional view of a chip mounting apparatus according to a second example of the present invention.

FIG. 13 is a schematic plan view of a substrate holding stage of the apparatus according to the second example.

FIG. 14 is a timing chart of the chip mounting method according to the second example.

FIG. 15 is a timing chart of a chip mounting method according to a third example.

FIG. 16 is a timing chart of a chip mounting method according to another modification.

### EXPLANATION OF SYMBOLS

1: chip
1a: bump
2: tool
3: Z-axis feeding device
4: substrate holding stage
5: substrate
5a: electrode
6: servomotor
7: feeding mechanism
8: slider
9: apparatus frame
10: guide rail
13: encoder
15: tool holder supporting means
16: holder bracket
17: tool holder
18: hydrostatic air bearing
19: pressurizing port
20: balance pressure port
22: drive control means
23: tool holder position detecting means
24: chip attracting hole
25: substrate attracting hole
26a, 26b: vibrator
27a, 27b: pressure controller
28: pressure control means for pressurizing port
29: pressure control means for balance pressure port
30: pump

### THE BEST MODE FOR CARRYING OUT THE INVENTION

Hereinafter, examples of the present invention will be explained referring to figures.

### Example 1

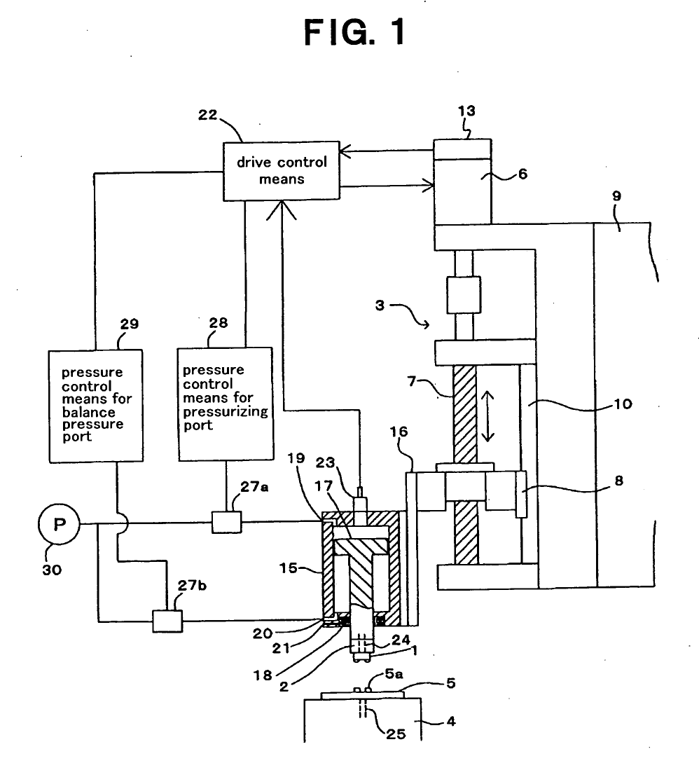

FIG. 1 shows a chip mounting apparatus according to this example. A Z-axis feeding device 3 provided to the chip mounting apparatus rotates a feeding mechanism (for example, a ball screw) by a servomotor 6 attached to an apparatus frame 9, and moves up and down a slider 8 screwed therewith by guiding it along a guide rail 10 attached to the apparatus frame 9. This Z-axis feeding device 3 corresponds to a drive means in the apparatus according to the present invention.

A tool holder supporting means 15 is provided on a tool holder bracket 16 attached to slider 8. Further, a tool holder 17 is installed in the inside of tool holder supporting means 15 at a condition capable of being moved up and down. A tool 2 has a heater, and this tool 2 is attached to the lower end of tool holder 17 so that both are integrated. A chip attracting hole 24 is provided to tool 2, thereby holding a chip 1. A substrate 5 is held on a substrate holding stage 4 having a substrate attracting hole 25. Where, tool holder supporting means 15 is formed by a cylinder tube of an air cylinder. Further, tool holder 17 is formed by a piston of the air cylinder. The tool holder 17 is installed in tool holder supporting means 15 via a hydrostatic air bearing 18 which is generally called as an air bearing.

Therefore, tool holder supporting means 15 has two air supply ports arranged vertically. The upper air supply port is a pressurizing port 19, and the lower air supply port is a balance pressure port 20. An air tube from a pump 30 is connected to pressurizing port 19 via a pressure controller 27a. The pressure controller 27a controls the pressure of pressurizing port 19 based on a signal of a pressure control means for pressurizing port 28. Further, an air tube from pump 30 is connected to balance pressure port 20 via a pressure controller 27b. The pressure controller 27b controls the pressure of balance pressure port 20 based on a signal of a pressure control means for balance pressure port 29. Pressures P1 and P2 controlled by pressure controllers 27a and 27b each capable of controlling the pressure are supplied from pressurizing port 19 and balance pressure port 20, the vertical movement of tool holder 17 can be controlled in a predetermined manner by a differential pressure between the air pressures, and tool 2 can be positioned at a predetermined level. Further, at that time, a load (pressurizing force) applied to chip 1 can be controlled by a fine differential pressure so as to cancel the dead weight of tool holder 17. Where, an electropneumatic regulator and the like can be used as pressure controllers 27a and 27b.

Since hydrostatic air bearing 18 can support the lower portion of tool holder 17 at a non-contact condition by uniformly dispersing the pressurized air supplied from a hole 21 provided to tool holder supporting means 15 by a porous material, the frictional resistance at the supporting portion is extremely small at a level capable of being ignored. Besides, because the head part of tool holder 17 is loosely fitted into tool holder supporting means 15 and the frictional resistance at this portion is also extremely small at a level capable of being ignored, tool holder 17 can be controlled by a fine pressure. Where, hydrostatic air bearing 18 is also called as a hydrostatic air linear bearing, because it can support tool holder 17 at a non-contact condition so as to allow a vertical movement but to prevent a rotational movement.

In this example, a tool holder position detecting means 23 (for example, an eddy- current type sensor and the like), which gives a positional information to a drive control means 22 of Z-axis feeding device 3 by detecting a position of the upper end of tool holder 17, is attached to tool holder supporting means 15. This tool holder position detecting means 23 corresponds to a tool holder position detecting means in the apparatus according to the present invention. Further, pressure control means for pressurizing port 28 and pressure control means for balance pressure port 29 are connected to drive control means 22. Where, to this drive control means 22, a detection signal of an encoder 13 attached to servomotor 6 is also given.

Because the above-described tool holder position detecting means 23 is provided, when bump 1a of chip 1, formed from a solder, is pressed onto electrode 5a of substrate 5 during the moving down of the Z-axis feeding device, the distance, at which tool holder 17 is lifted up and moved up (namely, a relative upward displacement relative to tool holder supporting means 15), can be detected. Therefore, even in a case where there exists a dimensional dispersion in a height direction in bump 1a, substrate 5 or electrode 5a or in a case where tool 2 is elongated by a thermal expansion, because the amount of the moving up ascribed thereto can be fed back to drive control means 22 of Z-axis feeding device 3, when the solder (material of bump) is cooled and solidified, an accurate positional control in the height direction relative to tool 2 can be achieved, and therefore, the mounting can be performed at a good bump form. Here, the “good bump form” means a form which does not generate a short-circuit failure by breakage of bump, etc., and a mechanically stable form against thermal stress, etc.

Hereinafter, the operation of the apparatus according to Example 1 will be explained.

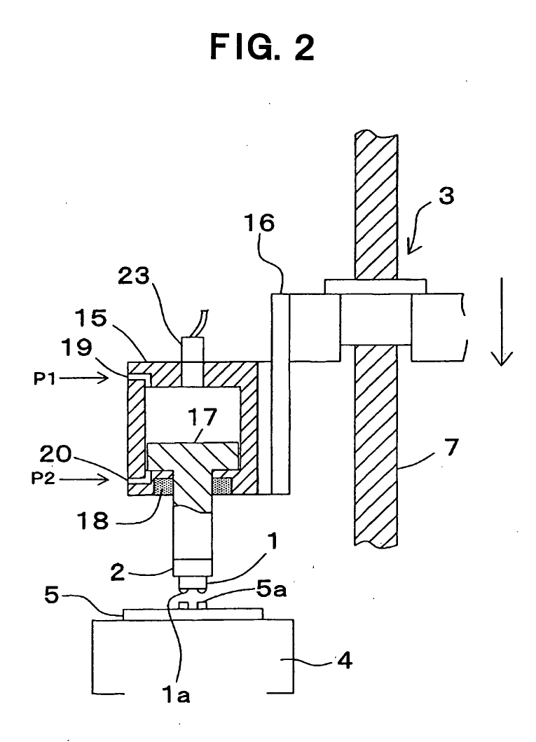

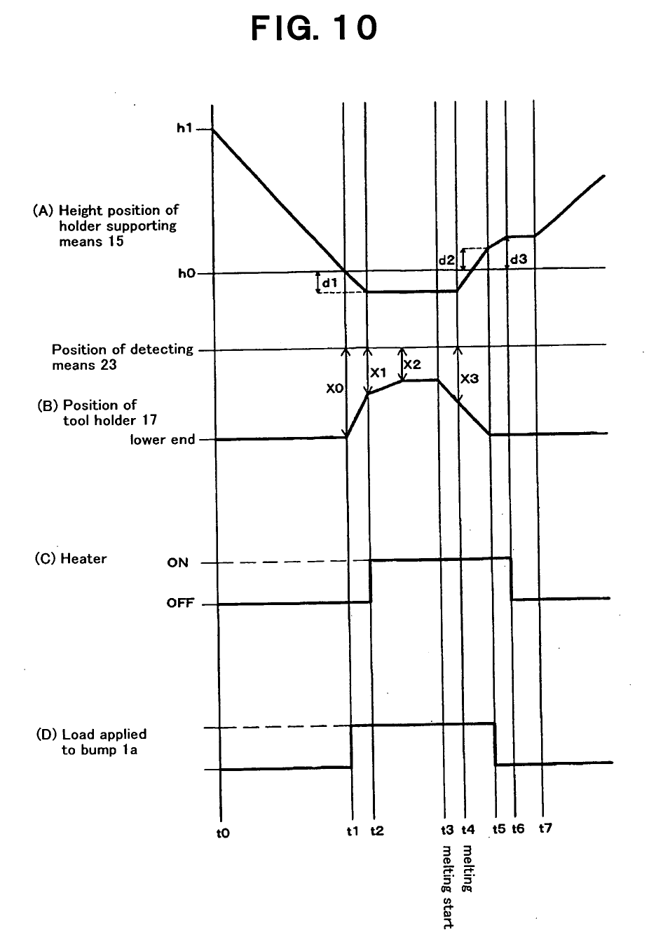

FIGS. 2 to 9 show a set of control mechanism for up and down movement (vertical movement) in mounting of chip 1 including tool holder supporting means 15 and tool holder 17. Further, FIG. 10 shows respective timings of the position in the height direction of tool holder supporting means 15, the position of tool holder 17, supply of electric power to the heater of tool 2, and the load applied to bump 1a. The graph depicted as (A) in FIG. 10 shows the height position of tool holder supporting means 15 in the mounting of chip 1, and the position at which the lower end of bump 1a of chip 1 comes into contact with electrode 5a of substrate 5 is set as the reference height (h0 in FIG. 10). The graph depicted as (B) in FIG. 10 shows the position of tool holder 17 in tool holder supporting means 15, and the position at which the lower end of tool holder 17 comes into contact with tool holder supporting means 15 is set as its lower end position. The graph depicted as (C) in FIG. 10 shows the ON/OFF timing in the supply of electric power to the heater of tool 2. The graph depicted as (D) in FIG. 10 shows the load (pressurizing force) applied to bump 1a of chip 1 and electrode 5a of substrate 5.

In the initial state where the mounting is to be started, tool holder supporting means 15 is present at the moving-up position as shown in FIG. 2 (timing t0, height h1 in FIG. 10). At that time, pressure P2 of balance pressure port 20 is reduced so that tool holder 17 comes into contact with the lower part of tool holder supporting means 15 by the differential pressure between pressure P1 of pressurizing port 19 and pressure P2 of balance pressure port 20, so that tool holder 17 does not vibrate by its force of inertia when Z-axis feeding device 3 is operated at a high speed. With respect to the differential pressure in this case, as long as tool holder 17 can come into contact with the lower part of tool holder supporting means 15, pressure P1 of pressurizing port 19 may be increased.

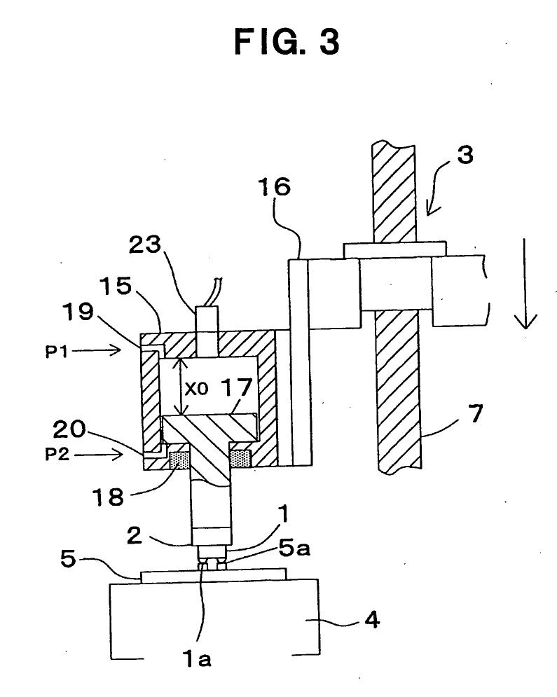

Then, by operating Z-axis feeding device 3, tool holder supporting means 15 is moved down in a manner integrated with tool 2 holding chip 1. FIG. 3 shows a state where bump 1a of chip 1 has come into contact with electrode 5a of substrate 5 on the way during the moving down of tool holder supporting means 15 (timing t1 in FIG. 10). The distance between tool holder position detecting means 23 and tool holder 17 at this time is referred to as “X0”. The distance X0 corresponds to the first position in the present invention. Further, at this time, pressure P2 of balance pressure port 20 is increased or decreased in order to control the pressure applied to bump 1a of chip 1 at a predetermined pressure. In this case, pressure P1 of pressurizing port 19 may be increased or decreased. Thus, because tool holder a7 is supported by hydrostatic air bearing 18 and the pressure is controlled to be constant by the differential pressure between pressure P1 of pressurizing port 19 and pressure P2 of balance pressure port 20, the load (pressurizing force) applied to bump 1a of chip 1 at this time is maintained at a predetermined value, and the bump 1a almost is not deformed.

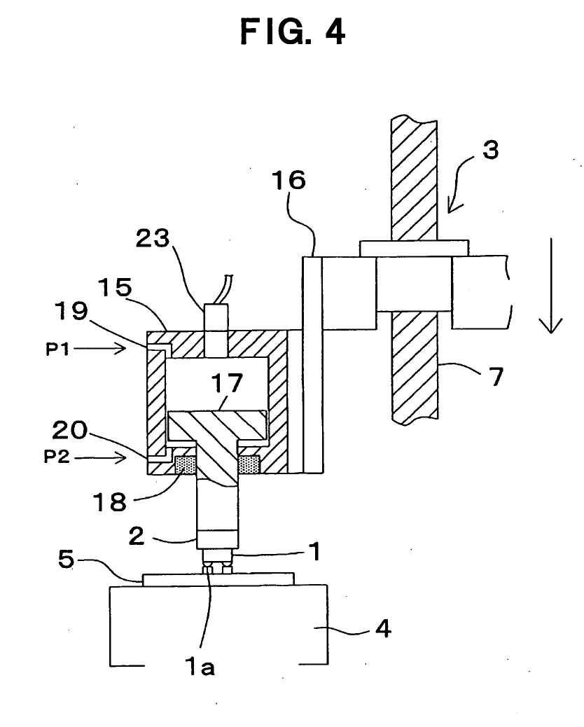

Further, when the feeding of tool holder supporting means 15 due to the operation of Z-axis feeding device 3 is continued, from the condition where bump 1a of chip 1 comes into contact with electrode 5a of substrate 5, tool holder 17 is lifted up (moved up) relatively to tool holder supporting means 15. FIG. 4 shows the state where tool holder 17 begins to leave from tool holder supporting means 15 (the state from timing t1 to timing t2 in FIG. 10). Because air is supplied to tool holder 17 from balance pressure port 20 and pressurizing port 19 also during the lifting up, the load (pressurizing force) applied to bump 1a of chip 1 is maintained at the predetermined value, and the bump 1a almost is not deformed.

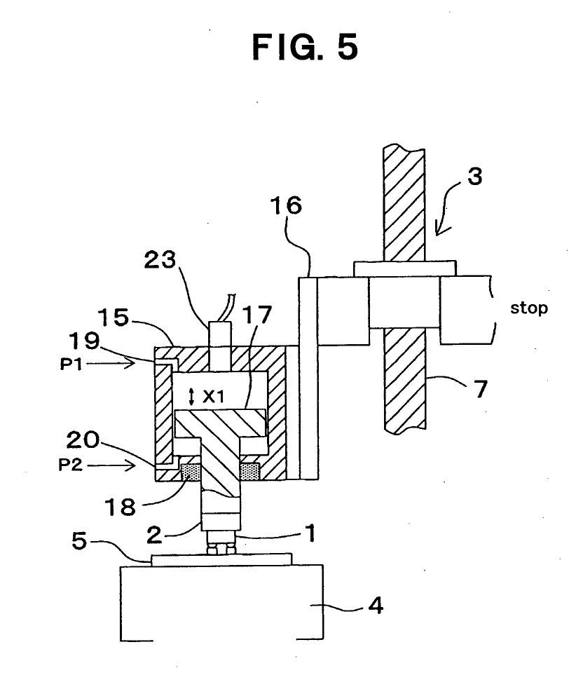

Then, as shown in FIG. 5, when the feeding amount of Z-axis feeding device 3 has reached a preset value d1 (pushing-in amount of bump 1a), the operation of Z-axis feeding device 3 is stopped (timing t2 in FIG. 10). Then, tool holder position detecting means 23 detects the position of tool holder 17 (the distance depicted as “X1” in FIG. 5). This distance X1 corresponds to the second position in the present invention. Where, in the condition shown in FIG. 4, because of dispersion of bump height, warp of substrate, etc., bumps 1a of chip 1 are not all brought into contact with electrodes 5a of substrate 5, and only a part of bumps 1a are brought into contact therewith. Therefore, when bump 1a is pushed in by a pushing-in amount d1 after the lower end of bump 1a of chip 1 has come into contact with electrode 5a of substrate 5, the feeding by Z-axis feeding device 3 is stopped. Next, an electric power is supplied to the heater of tool 2, and bump 1a of chip 1 is heated at a temperature of a melting point of the solder or higher.

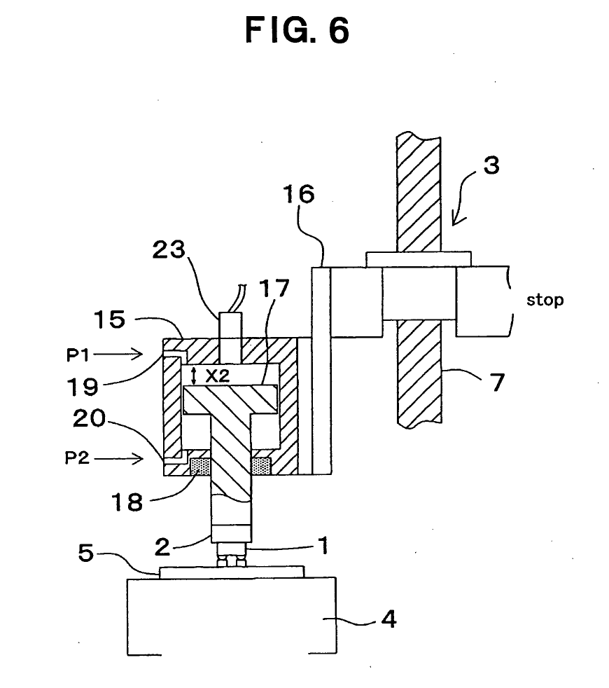

Then, as shown in FIG. 6, accompanying with the heating of tool 2, tool 2 is thermally expanded, and the distance between tool holder position detecting means 23 and tool holder 17 becomes X2. This distance X2 corresponds to the third position in the present invention. At that time, because the dead weight of tool holder 17 is cancelled and it is controlled at a small pressurizing force of several grams (for example, about 1 g to about 20 g), the bump form is not damaged. Namely, when bump 1a of chip is molten, since it can be pressed at a pressure at which the load (pressurizing force) of chip 1 is lower than the pressure in the inside of bump 1a, the surface layer of the solder is not broken by the load (pressurizing force) of chip 1, and bump crush does not occur.

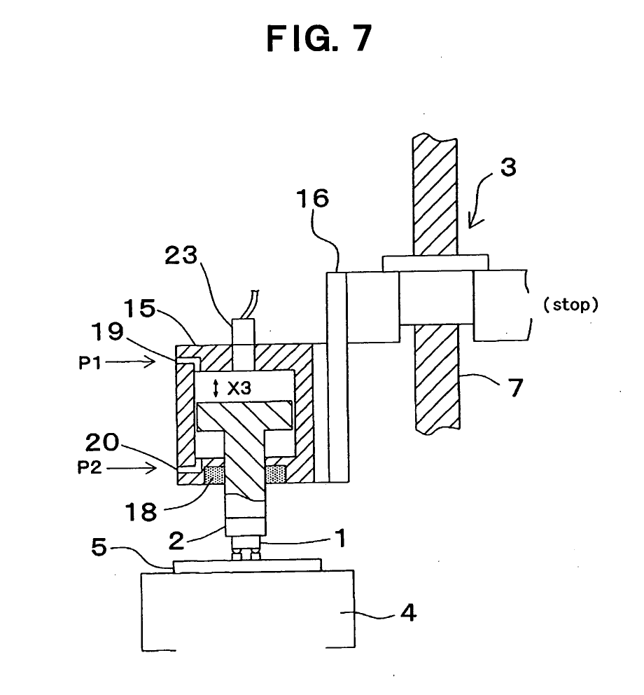

Thereafter, bump 1a is heated by tool 2 and begins to be molten (timing t3 in FIG. 10). When bump 1a is heated by tool 2 and its melting proceeds, a distortion occurs in the bump form, and tool holder 17 moves downward together with tool 2. At that time, a change of the distance between tool holder position detecting means 23 and tool holder 17 from the aforementioned X2 to a distance corresponding to a further downward position is detected. When the detected value reaches a predetermined value (X3 in FIG. 10), as shown in FIG. 7, it is determined that bump 1a has been molt5en (timing t4 in FIG. 10). X3 corresponds to the fourth position in the present invention.

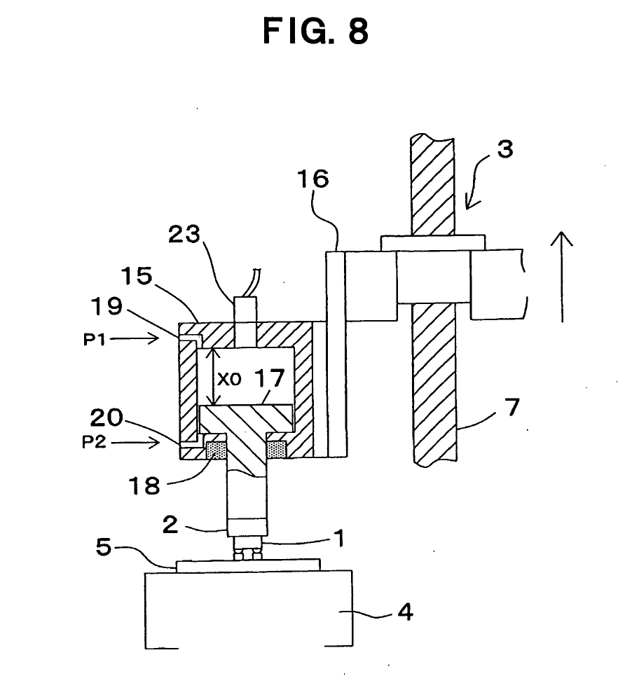

Then, the feeding in the upward direction by Z-axis feeding device 3 is started, tool holder position detecting means 23 detects X0. FIG. 8 shows a state where tool holder supporting means 15 is lifted up to a maximum position relative to tool holder 17 (timing t5 in FIG. 10). The height of tool holder supporting means 15 is controlled by drive control means 22 so that it becomes upper or lower by an amount determined by subtracting a bump press breaking amount L1 at timing t2 and a sinking amount L2 at the time of bump melting at timing t4 from an elongation H1 in the Z-axis direction due to the thermal expansion of tool 2, as compared with the height of tool holder supporting means 15 at the timing t1 in FIG. 10 (d2 in FIG. 10, lifting up amount of tool holder 17). In this condition, the lower end of tool holder 17 present in tool holder supporting means 15 is being brought into contact with the tool holder supporting means 15, the gap between chip 1 and substrate 5 becomes only a value corresponding to the height determined by subtracting the bump press breaking amount L1 and the sinking amount L2 at the time of bump melting from the sum of the height of bump 1a and the height of electrode 5a, and therefore, the thermal expansion of the heater can be cancelled.

Then, the demand value d3 sent to Z-axis feeding device 3 is calculated by drive control means 22 so that the gap (gap amount) between chip 1 and substrate 5 at the time of cooling becomes a predetermined value, and the feeding due to Z-axis feeding device 3 is carried out (the value d3 is calculated from the pushing-in amount d1 of bump 1a, the respective measured values detected by tool holder position detecting means 23, a set value G1 of solder bump height and a set value G2 of gap height described later). Then, the attraction of chip 1 is turned OFF, the vacuum pressure for the chip attraction is returned to an atmospheric pressure, and the supply of electric power to the heater of tool 2 is turned OFF. Then, at a state where the feeding by Z-axis feeding device 3 is being stopped, bump 1a of chip 1 held by tool 2 is cooled (timing t6 in FIG. 10).

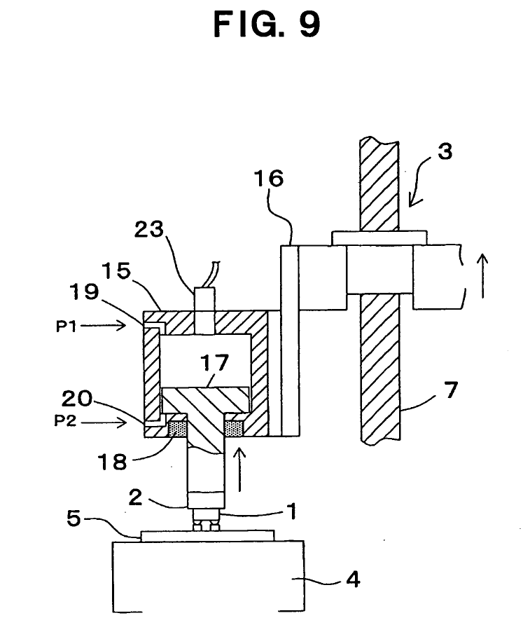

Then, as shown in FIG. 9, when the feeding in the upward direction by Z-axis feeding device 3 is carried out, tool holder 17 is lifted up (timing t7 in FIG. 10).

Where, the timings t5 and t6 in FIG. 10 may be carried out as a same timing.

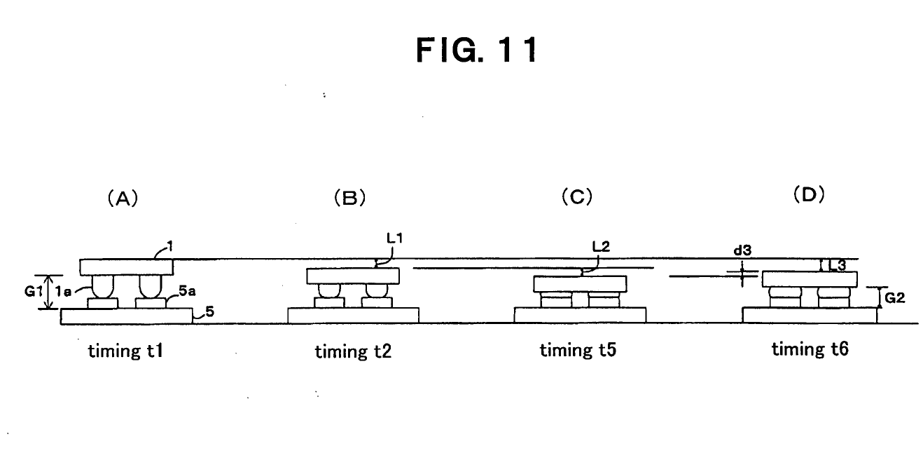

Next, the control parameters processed in drive control means 22 will be explained referring to FIGS. 10 and 11.

FIG. 11 shows a bonding state of chip 1 and substrate 5. In FIG. 11, (A) shows a state of chip 1 and substrate 5 at the timing t1 in FIG. 10. The gap at the contact time of chip 1 and substrate 5 is processed as a control parameter G1 (a set value of solder bump height) by drive control means 22.

In FIG. 11, (B) shows a state of chip 1 and substrate 5 at the timing t2 in FIG. 10. The pushing-in amount of chip 1 is processed as a control parameter L1 by drive control means 22. L1 is calculated from pushing-in amount d1 of bump 1a, first position X0 and second position X 1 in FIG. 10 by an equation of L1=d1−(X0−X1). L1 is determined as a value pushed in by an amount corresponding to the load (pressurizing force) applied to bump 1a of chip 1.

In FIG. 11, (C) shows a state of chip 1 and substrate 5 at the timing t5 in FIG. 10. The sinking amount at the time of melting of bump 1a is processed as a parameter L2 by drive control means 22. L2 is calculated from third position X2 and fourth position X3 in FIG. 10 by an equation of L2=X3−X2. Further, when the elongation in the Z-axis direction due to the thermal expansion of the heater is referred to as H1, H1 is calculated by an equation of H1=X1−X2. In FIG. 10, the pushing-in amount d1 of bump 1a and the lifting-up amount d2 of tool holder 17 have a relationship of d1+d2=X0−X3. Therefore, the lifting-up amount d2 of the tool holder is calculated by drive control means 22 so that d2=H1−(L1+L2) is satisfied, thereby controlling Z-axis feeding device 3.

In FIG. 11, (D) shows a state of chip 1 and substrate 5 at the timing t6 in FIG. 10 when bump 1a is cooled. The gap between chip 1 and substrate 5 after cooling of bump 1a is processed as a control parameter G2 (a gap height set value) by drive control means 22. From (A) and (D) of FIG. 11, the chip sinking amount L3 has a relationship of L3=G1−G2. Further, the demand value d3 to Z-axis feeding device 3 has a relationship of L3=L I+L2-d3. When L1=d1−(X0−X1) and L2=X3−X2 are substituted for this relationship, L3=d1−(X0−X1+X2−X3)−d3 stands. Therefore, the demand value d3 to Z-axis feeding device 3 is controlled so as to satisfy d3=d1−(X0−X1+X2−X3)−(G1−G2).

For example, when the control was carried out at set conditions of G1 of 30 μm and G2 of 23 μm and at the demand value d1 of 10 μm, it was determined that X0 was 2000 μm, X1 was 1995 μm, X2 was 1985 μm and X3 was 1989 μm, and the demand value d3 was processed by drive control means 22 so as to become 2 μm and it was demanded to Z-axis feeding device 3. Depending upon the setting condition of G2, there is a case where the value of d3 becomes a value smaller than d2. In this case, the cooling of bump 1a can be carried out while the load (pressurizing force) applied to chip 1 is kept. Further, in a case where the value of d3 is greater than the value of d2, the cooling of bump 1a can be carried out at a condition where the load (pressurizing force) applied to chip 1 is zero.

As described hereinabove, when chip 1 and substrate 5 are mounted, by setting the gap G1 at the contact time, the gap G2 at the cooling time and the pushing-in amount d1 of bump 1a and determining the distance values X0, X1, X2 and X3 between tool holder position detecting means 23 and tool holder 17, the demand value d3 to the Z-axis feeding device at the cooling time can be determined, the time for deciding a gap amount by trial beforehand can be omitted, and in accordance with the properties of bump 1a, setting of conditions high in reliability without mistake due to human handling can be carried out in a short period of time.

### Example 2

In this example, the structure of substrate holding stage 4 is different from that of Example 1, explanation of the same structural parts as those in Example 1 is omitted by providing thereto the same symbols as those in Example 1, and the different part will be explained concretely.

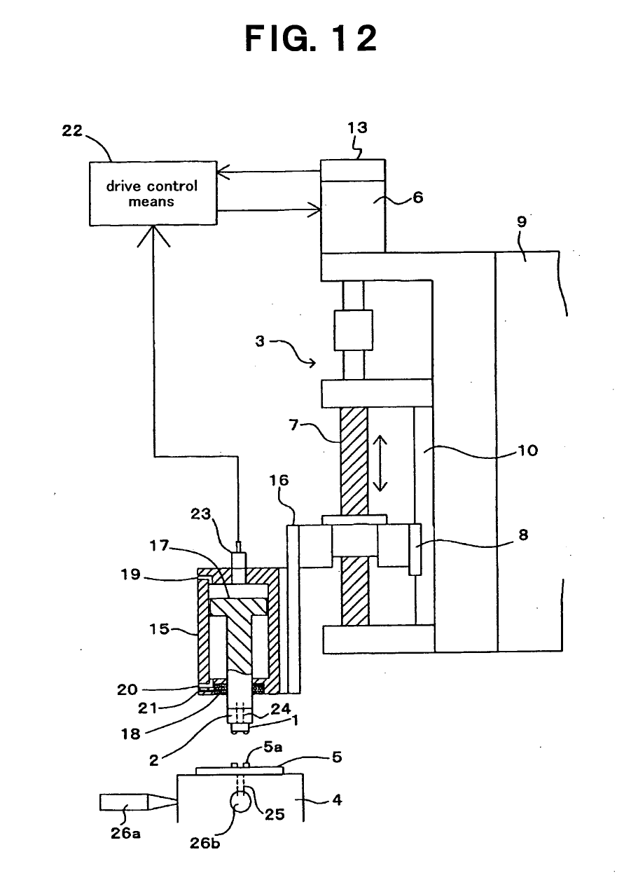

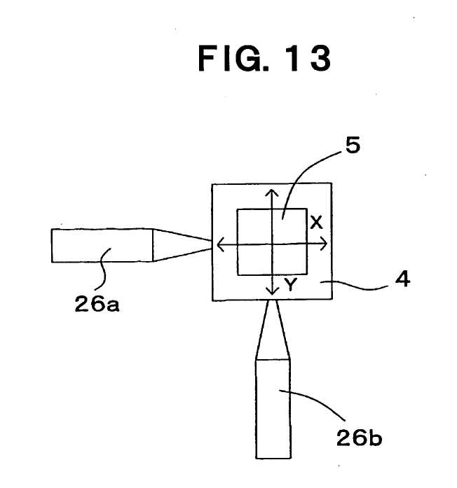

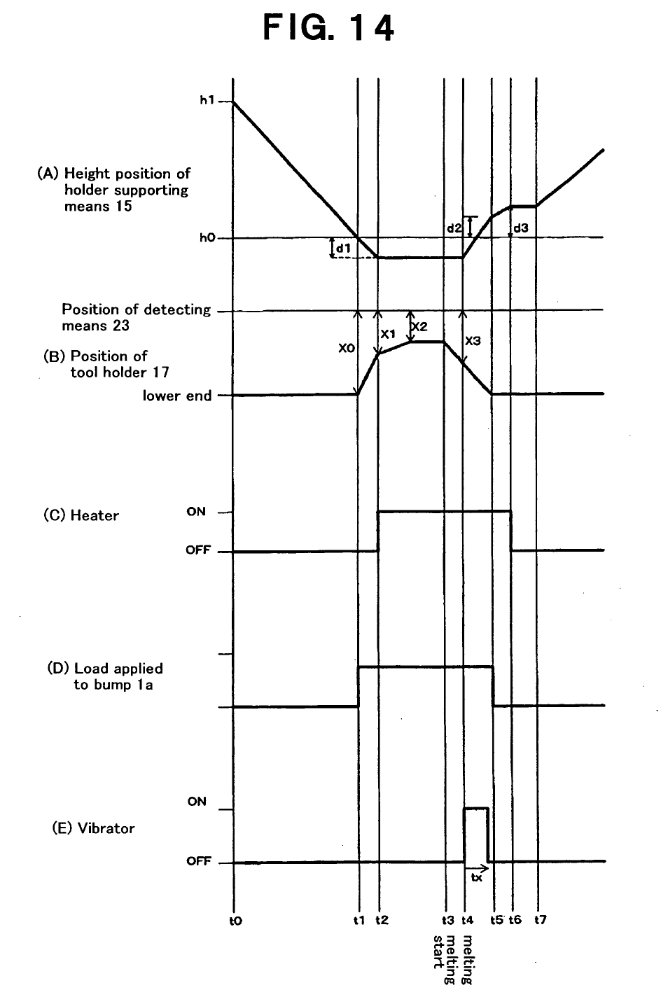

FIG. 12 shows a chip mounting apparatus according to Example 2, FIG. 13 shows a schematic plan view of a substrate holding stage of the apparatus according to Example 2, and FIG. 14 shows a timing chart of the chip mounting method according to Example 2.

In this chip mounting apparatus, as shown in FIG. 13, vibrators 26a and 26b are provided to substrate holding stage 4, vibrations in the directions perpendicular to each other (X and Y directions) are given to substrate holding stage 4, and via them, vibrations in two directions are given to substrate 5 held by substrate holding stage 4. By this complex vibration in directions X and Y, a fine relative complex vibration occurs between bump 1a of chip 1 and electrode 5a of substrate 5, and a friction occurs by this relative complex vibration. By this friction, an oxide layer which has been present on bump 1a or electrode 5a is broken and removed efficiently and surely.

FIG. 14 (E) shows the timing of ON/OFF of vibrators 26a and 26b (FIG. 14 (A), (B), (C) and (D) are timing charts similar to those in FIG. 10). In this chip mounting method, during a predetermined time (time tx in FIG. 14) from the time when bump 1a of chip 1 begins to melt (timing t4 in FIG. 14), vibrators 26a and 26b provided to substrate holding stage 4 operate, and a fine relative complex vibration is caused between bump 1a of chip 1 and electrode 5a of substrate 5.

### Example 3

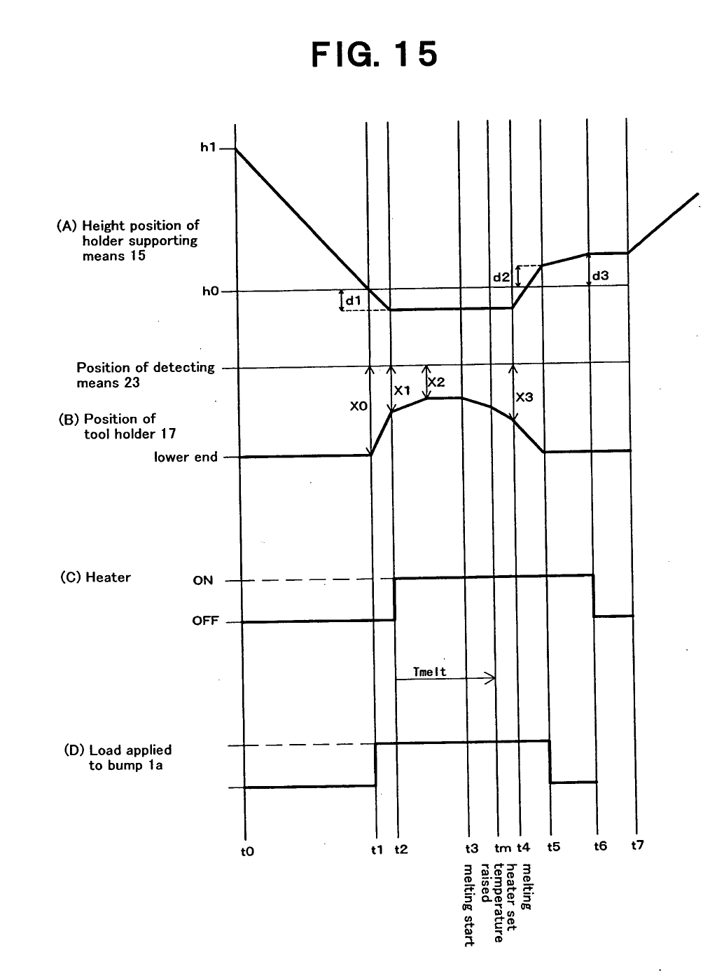

In this example, mounting is carried out after the melting time of bump 1a in Example 1 is measured. First, the melting time of bump 1a shown in the timing chart depicted in FIG. 10 in Example 1 (time from t2 to t4) is measured at the production starting time. The melting time of bump 1a slightly varies because the melting temperature of solder bump varies depending upon the production lot of bump 1a. Therefore, the melting time of solder bump is measured at the initial production such as a time changing the type of chip 1 to be mounted (the first production of the mounting operation). The measured melting time (Tmelt shown in the timing chart depicted in FIG. 15) is memorized in drive control means 22, and it operates as a timer for monitoring melting in the following production of chip mounting.

In Example 3, as shown in FIG. 15, after heater ON, in a case where the position of tool holder 17 after expiring the time Tmelt does not reach X3 (in a case where the solder is not molten), the set temperature of the heater is raised, thereby melting bump 1a surely.

Thus, by providing the melting monitor timer, even if the melting of solder bump varies, the mounting of the chip to the substrate can be carried out in a stable period of time. Where, in order to melt the solder bump, the heater elevating the heater may be a heater for heating from lower side.

Although typical three examples have been described hereinabove, chip 1 in the present invention means a concept including all members of the side mounted to substrate 5, regardless of its kind or its size, for example, such as an IC chip, a semiconductor chip, an optical element, a surface mounting member, or a wafer. Further, substrate 5 means a concept including all members of the side mounted with chip 1, regardless of its kind or its size.

Further, as the means for holding (or supporting) substrate 5 on the upper surface of substrate holding stage 4, any type of holding means may be employed, such as an attractive holding means by substrate attracting hole 25 (suction hole), an electrostatic holding means by static electricity, a magnetic holding means by a magnet or a magnetism, a mechanical means in which a substrate is grasped by a plurality of movable claws, a mechanical means in which a substrate is pressed by a single or a plurality of movable claws, etc.

Further, substrate holding stage 4 may be provided to either a fixed base or a movable base as needed, and in a case where it is provided to a movable base, it may be provided so as to be controlled in various manners such as parallel movement control, rotational movement control, vertical movement control, parallel and rotational movement control, parallel and vertical movement control, rotational and vertical movement control, parallel and rotational and vertical movement control, etc.

Further, bump 1a provided to chip 1 means an object to be bonded to electrode 5a (for example, an electrode, a dummy electrode, etc.) provided on substrate 5, for example, such as a usual type solder bump, a stud bump, etc. Further, electrode 5a provided on substrate 5 means a counter object to be bonded with bump 1a provided to chip 1, for example, such as an electrode accompanying a wire, a dummy electrode which is not connected to a wire, etc.

Further, feeding mechanism 7 and Z-axis feeding device may be any type mechanism and device as long as slider 8 can be moved, for example, such as a ball screw type, a linear motor type, etc.

Further, the chip mounting apparatus according to the present invention means an apparatus of a broad concept including, in addition to a mounting apparatus for mounting a chip or a bonding apparatus for bonding a chip, for example, an apparatus for fixing or transferring objects being contacted with each other beforehand (such as being mounted or being temporarily press bonded), such as a substrate and a chip, or a substrate and an adhesive (ACF (Anisotropic Conductive Film), NCF (Non Conductive Film)), by pressing, heating and/or vibrating means (such as ultrasonic wave, piezo element, magnetostrictive element or voice coil).

Further, in the above-described examples, although tool 2 is moved down at a condition where chip 1 is held by tool 2, and the chip 1 is pressed onto substrate 5, the present invention is not limited thereto. For example, a method may be employed wherein a chip is mounted beforehand on a substrate by using an adhesive and the like, and the chip is pressed onto the substrate by moving down a tool which does not hold the chip. In this case, by bringing the tool into contact with the chip which is mounted on the substrate beforehand, the tool and the chip are brought into contact with the substrate at a condition where the tool and the chip are one over another.

Further, the tool attachment condition is not limited to a condition where tool 2 is attached directly to the lower end of tool holder 17, if necessary, a load cell may be interposed.

Further, tool holder position detecting means 23 is not limited only to a eddy current type sensor, another sensor may be employed (such as a laser or optical sensor).

Further, in a case where the pressurizing force is high, the pressurizing force may be controlled only by the pressurizing port without using the balance pressure port. Further, the heigh detecting means is not limited to means for measuring the height position of tool 2 by detecting the height position of tool holder 17, and the heigh detecting means may directly detect the height position of tool 2.

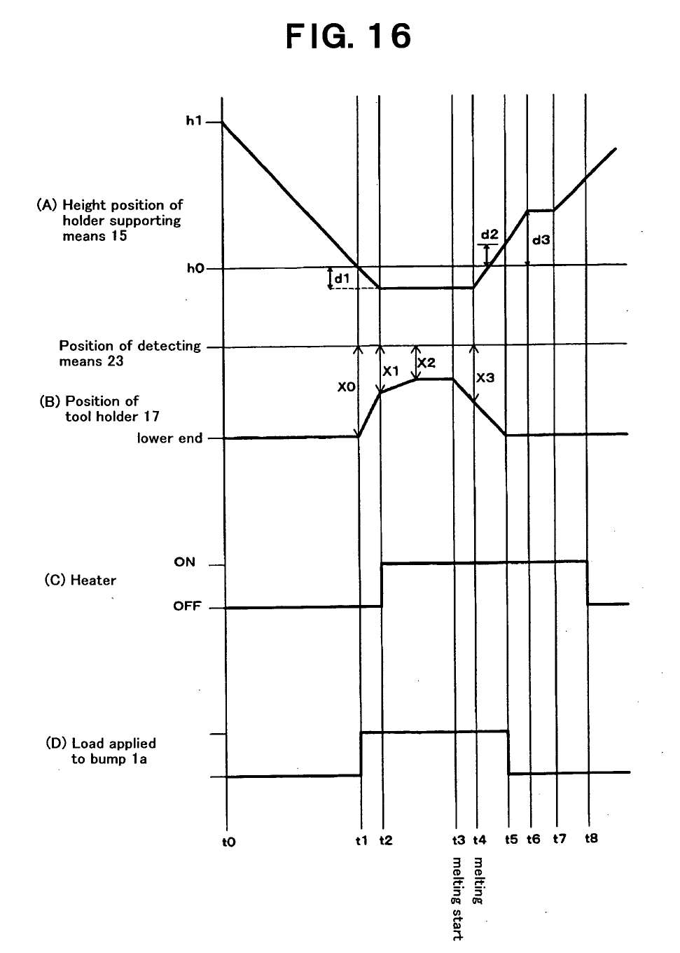

Furthermore, as to the timing of OFF of supply of electric power to the heater of tool 2, it may be turned OFF after a predetermined time expires from the timing t7 at which tool holder 17 is lifted up. Thus, by delaying the OFF timing of electric power supply to the heater, the melting of bump 1a of chip 1 can be made to be sure (timing t8 in FIG. 16).

Further, although the heater is provided to tool 2 in Examples 1 and 2, it may be provided to substrate holding stage 4. The heating structure may be a structure capable of heating chip 1 and substrate 5 efficiently, and the elongation in the Z-axis direction due to the thermal expansion of tool 2 accompanying with the heating can be detected by tool holder position detecting means 23. Furthermore, heaters may be provided to both sides of tool 2 and substrate holding stage 4. By this structure, heating of chip 1 and substrate 5 can be carried out in a short period of time, and moreover, if the heating is carried out by a pulse heater using a ceramic heater, temperature elevation with a good response becomes possible.

### INDUSTRIAL APPLICATIONS OF THE INVENTION

The chip mounting apparatus and chip mounting method according to the present invention can be applied to any chip mounting wherein a chip is mounted onto a substrate using a tool capable of being moved up and down.

1. A chip mounting apparatus having a tool for applying a pressure to a chip, a tool holder mounted with said tool, a tool holder supporting means for supporting said tool holder to be vertically moved, a drive means for vertically moving said tool holder supporting means, and a tool holder position detecting means for detecting a relative position of said tool holder to said tool holder supporting means, said apparatus comprising:
a drive control means for controlling a height and a pressuring force of said tool, based on a position of said tool holder when said tool and said chip are one over another and brought into contact with a substrate.

2. The chip mounting apparatus according to claim 1, wherein said drive control means comprises means for calculating and controlling an amount to be lifted up of said tool holder from a parameter with respect to a gap between said chip and said substrate when said chip and said substrate are brought into contact with each other, a parameter with respect to a pushing-in amount when said chip is pushed in to said substrate, and a parameter with respect to said relative position of said tool holder detected by said tool holder position detecting means.

3. A chip mounting method for press bonding a bump of a chip to an electrode provided on a substrate by moving down a tool holder, supported to be vertically moved by a tool holder supporting means, from an upper side of said substrate held by a substrate holding stage, and by applying a pressure to said chip via a tool mounted on said tool holder, said method comprising the steps of:
pressing said bump of said chip to said electrode of said substrate at a predetermined pressure by moving down said tool;
detecting a relative position of said tool holder to said tool holder supporting means by a tool holder position detecting means;
heating said bump of said chip, formed by a solder, at a temperature of a melting point of said solder or higher by supplying an electric power to a heater of said tool;
determining that said bump of said chip has been molten when said relative position of said tool holder, detected by said tool holder position detecting means, has reached a predetermined position; and
thereafter, lifting up said tool holder supporting means.

4. The chip mounting method according to claim 3, wherein, after said bump of said chip has been molten, a relative friction is generated between said bump of said chip and said electrode of said substrate, and an oxide layer on a surface of said solder is broken and removed by said friction.

5. The chip mounting method according to claim 3, wherein said bump of said chip is bonded to said electrode provided on said substrate at a condition where a pressure of said chip when said bump of said chip is molten is set at a pressure lower than a pressure in a fluidized solder.

6. The chip mounting method according to claim 3, wherein, by said tool holder position detecting means, a first position of said tool holder when said bump of said chip and said electrode of said substrate come into contact with each other is detected, then a second position of said tool holder when said tool is pushed in to the side of said substrate is detected, and thereafter a third position of said tool holder when said tool is heated by supplying an electric power to said heater of said tool is detected, then it is determined that said bump of said chip has been molten when a position of said tool holder, detected by said tool holder position detecting means, has reached a fourth position, said tool holder supporting means is lifted up until said tool holder reaches said first position, and while a gap between said chip and said substrate is maintained at a constant gap, said solder is solidified.

7. The chip mounting method according to claim 6, wherein an amount of lifting up of said tool holder at the time of solidifying said solder is determined from a predetermined gap between said chip and said substrate when said bump of said chip has been solidified, a gap between said chip and said substrate when said bump of said chip and said electrode of said substrate come into contact with each other, a pushing-in amount when said tool is pushed in to the side of said substrate, said first position of said tool holder, said second position of said tool holder, said third second position of said tool holder, and said fourth position of said tool holder.

8. The chip mounting method according to claim 6, wherein a time from the timing of heating said tool by supplying an electric power to said heater of said tool to the timing when said bump of said chip is molten is measured beforehand, and in a case where a height of said tool does not reach a height at the time when said bump is molten within said time measured beforehand, a set temperature of an upper heater or a lower heater is raised to melt said solder.
